(19) United States
(12) Patent Application Publication
(10) Pub. No.: US 2012/0104032 A1
(43) Pub. Date: May 3, 2012

(54) Feed Dispensing Machine

(76) Inventor: Craig D. Bahn, Windsor, PA (US)

(21) Appl. No.: 12/917,531

(22) Filed: Nov. 2, 2010

(51) Int. Cl. B65B 1/12; B65B 1/32; B65B 1/46; G07F 13/00

(52) U.S. Cl. 222/1; 222/77; 222/64; 222/23; 222/138

(57) ABSTRACT

A feed dispensing machine for delivering ready access feed to farmers, horse owners and the equivalent. The feed dispensing machine having a controller, a storage container, a surge container, a first conveyor system, a level sensor, a weighing mechanism, and a second conveyor system. The first conveyor system connects the storage container to the surge container while the level sensor is positioned within the surge container to signal capacity of bulk material within the surge container. The weighing mechanism includes a scale and connects to the controller. The second conveyor system connects the surge container to the weighing mechanism, and is positioned above the scale.

### FIELD OF THE INVENTION

The invention relates to a dispensing machine, in particular, it relates to a feed dispensing machine for delivering a quantity of bulk material based on selected weight.

### BACKGROUND

In order to feed their livestock, farmers are required to pick up pre-filled containers of feed or have a large quantity of bulk feed delivered locally. Horse breeders or owners are required to do the same. The amount and type of feed given will depend on the animal's type, age, weight, health, workload, the climate and what is locally available. While pre-filled containers of feed can accommodate use of varying feed, the pre-filled containers are generally expensive and cumbersome to transport and store. Even delivery of a large quantity of bulk feed is problematic, since the feed needs storage and the required type of feed may change over time. As a result, there is a need to provide feed in a better way.

Bulk food vending is well-known wherein a customer interacts with a user interface to select and pay for supply stored within a vending machine. A supplier may position the vending machine strategically, which is stationed wherever substantial numbers of customers will have ready access to them. The customer generally has varying options. There are essentially two basic types of such vending machines recognizably known. The first type of vending machine is a package vendor, which includes a number of pre-filled containers. The second known type of vending machine utilizes a control mechanism to select product by volume. For instance, many candy vending machines control the amount of bulk supply through an adjustable wheel, which measures out the supply in sized containers, and delivers the product through a supply duct. These machines are not very accurate in dispensing repeatably consistent amounts of product, since the dispensing is performed by volume and not weight.

### SUMMARY

It is an object of the invention to provide an improved feed dispensing machine strategically stationed for ready access by users.

The feed dispensing machine includes a controller, a storage container, a surge container, a first conveyor system, a level sensor, a weighing mechanism, and a second conveyor system. The first conveyor system connects the storage container to the surge container. The level sensor is positioned within the surge container and signals capacity of bulk material within the surge container. The weighing mechanism includes a scale and connects to the controller. The second conveyor system connects the surge container to the weighing mechanism, and is positioned above the scale.

### BRIEF DESCRIPTION OF THE DRAWINGS

The invention will be explained in greater detail below with reference to embodiments, referring to the appended drawings, in which:

FIG. 1 is a perspective view of a feed dispensing system according to the invention;

FIG. 2 is a perspective sectional view of the feed dispensing system showing internal components according to the invention;

FIG. 3 is a top plan view of the internal components of the feed dispensing system according to the invention;

FIG. 4 is a side elevation view of the feed dispensing system according to the invention;

FIG. 5 is a front view of mechanisms of the feed dispensing system showing the internal components according to the invention; and

FIG. 6 is a close up perspective view of the feed dispensing system according to the invention.

### DETAILED DESCRIPTION OF THE EMBODIMENT(S)

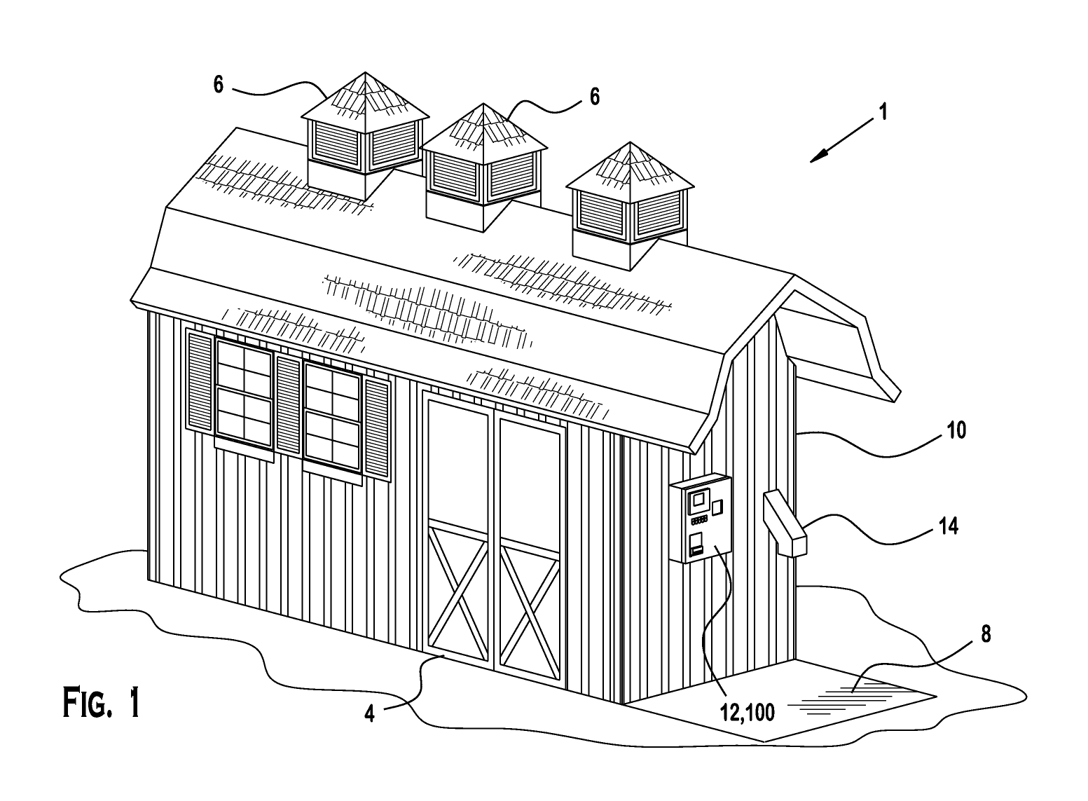

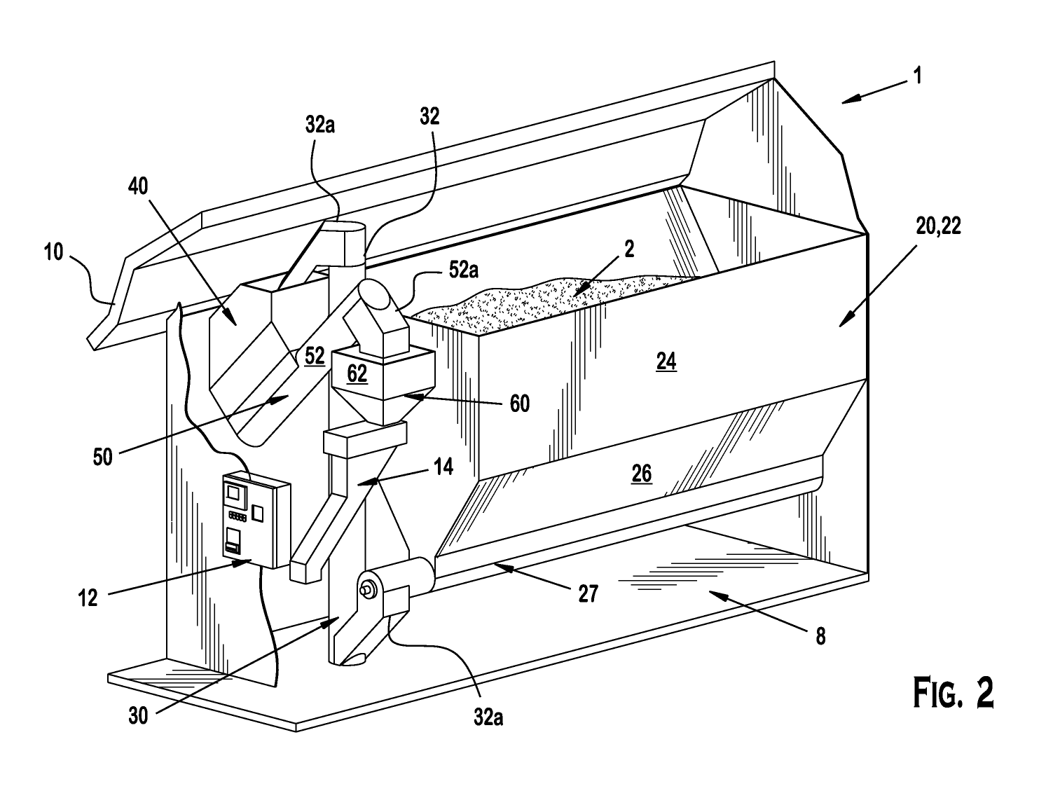

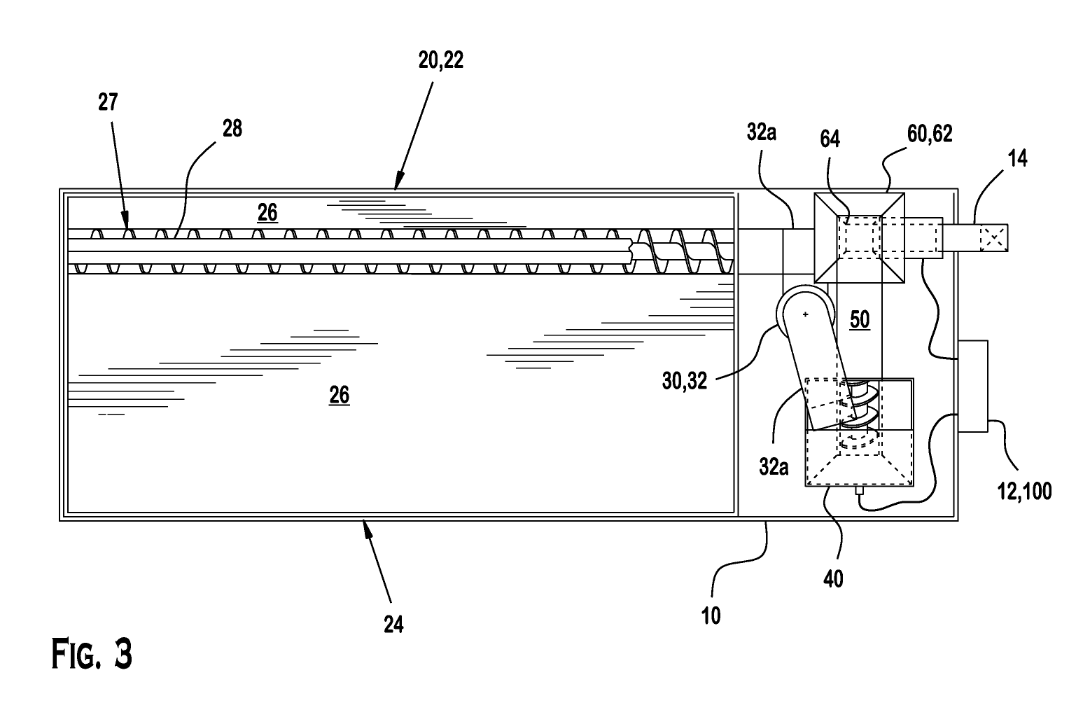

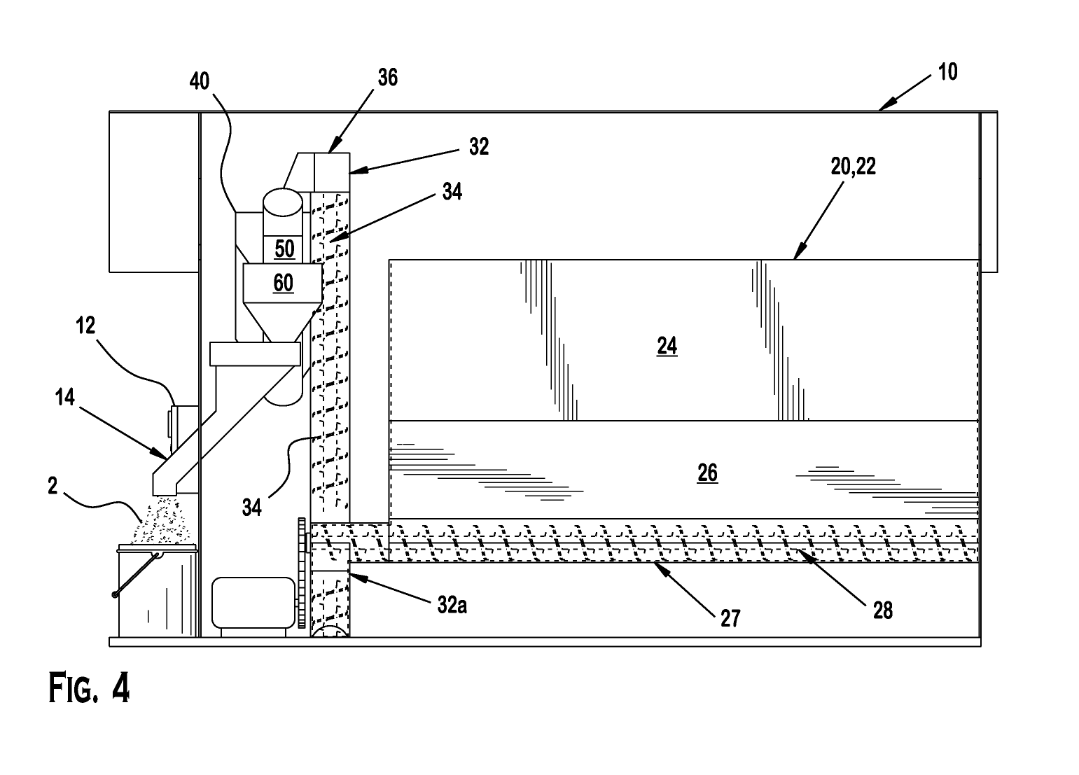

FIGS. 1-6 show a feed dispensing system 1 according to the invention, which includes a housing 10, a user interface 12, a supply duct 14, and internal components (see FIGS. 2-6).

In the embodiment shown, the housing 10 is shaped as a shed or barn. However, the housing 10 can be any type of housing 10, which is capable of sealing and protecting stored feed and the mechanical components housed inside the feed dispensing system 1. The housing 10, as shown, includes a door 4 and a number of inlets 6 rising from the housing 10. A maintenance worker can access the inside of the housing 10 through either the door 4 or the inlets 6. However, the door 4 provides access to perform maintenance and repairs on the internal components, while the tower 6 opens to easily supply and/or re-supply feed into the feed dispensing system 1.

In the embodiment shown, the user interface 12 includes a controller 100, such as a computer microprocessor, a money acceptor, and a user panel. The user interface 12 is positioned on an outside of the housing 10, and extends into the interior of the feed dispensing system 1. The user interface 12 sends signals to a controller 100, which commands internal components to perform functions. Also, the user interface 12 includes all external controls and displays, through the user panel, which allows a user to conduct orders or requests from outside the feed dispensing system 1. For instance, in the embodiment shown, the user interface 12 includes a digital display unit, buttons, and a payment device. The display unit provides instruction and order details, while the payment device allows the user to pay for the order/request. The buttons are included with the user interface 12 to allow the user to select order specifications, including size, payment, and receipt.

In the embodiment shown, the supply duct 14 is a structural passageway for transporting bulk material 2 from inside the feed dispensing system 1. The supply duct 14 is inclined, extending through the housing 10 of the feed dispensing system 1.

In another embodiment, a second housing (not shown) is provided, which covers an area around the user interface 12 and supply duct 14. Accordingly, this second housing is an overhead roof or structure further projection from the housing 10. The second housing is used to provide shelter for a customer. The second housing would be both self supporting and connect to the adjacent housing 10, and include an opening (i.e. door, ramp, etc.) that leads into an interior of the second housing (not shown). Lighting and other practical affects may be utilized to provide for a safe and user friendly environment.

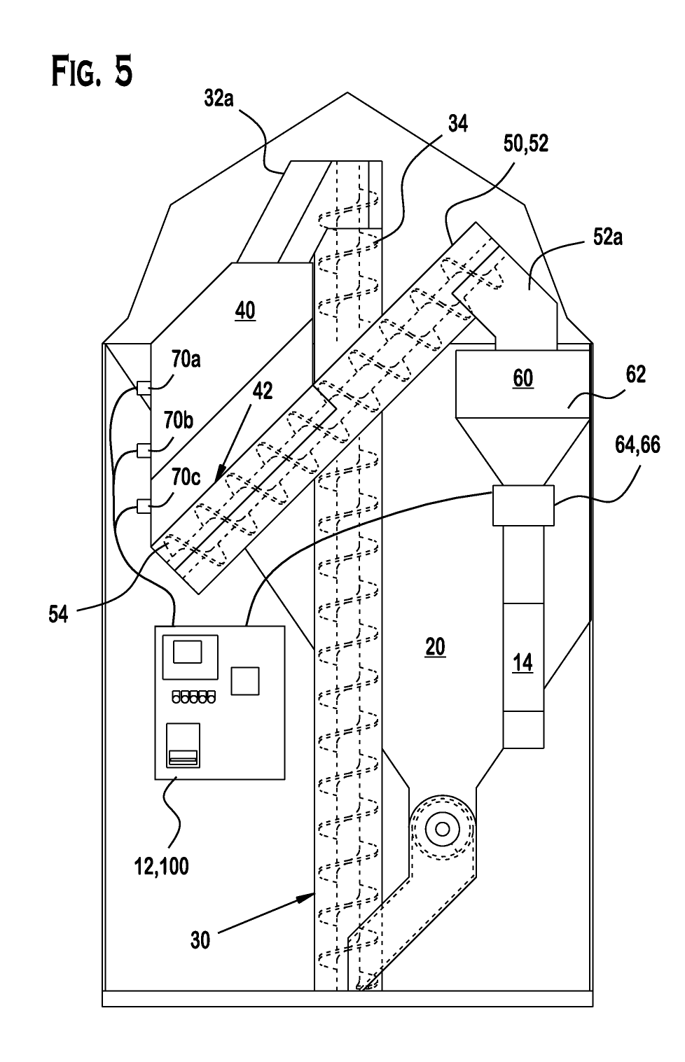

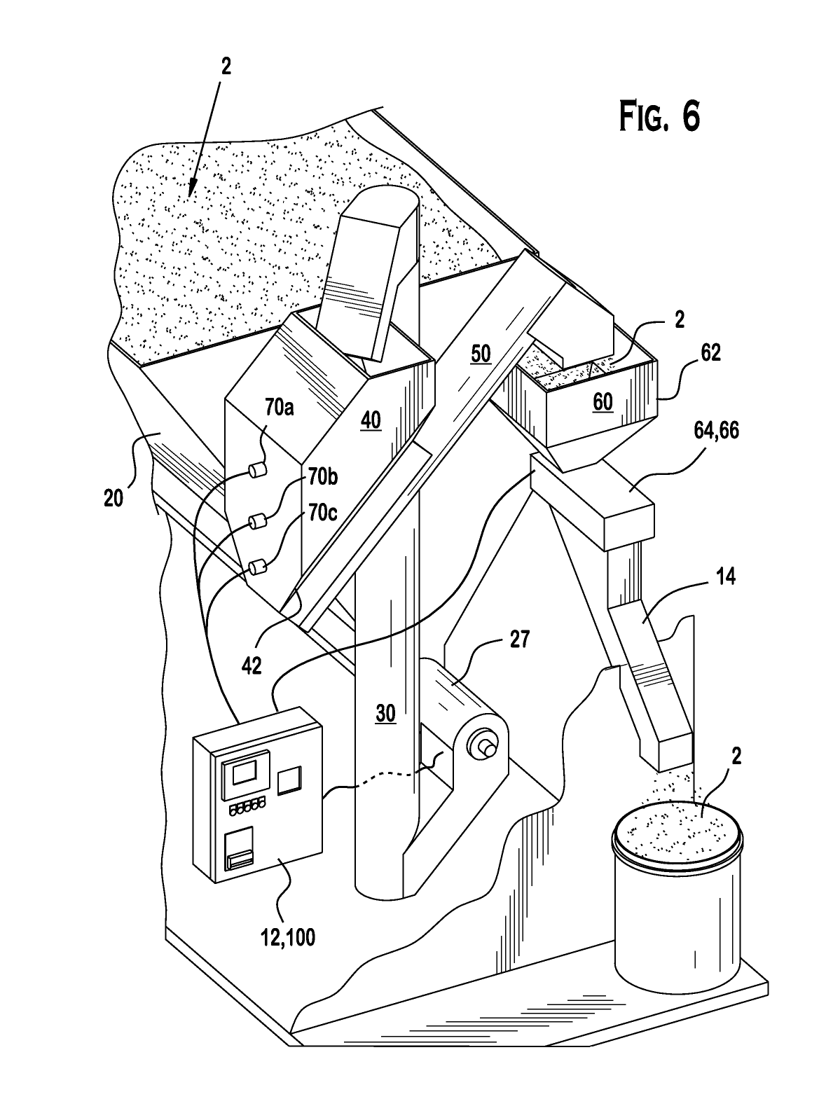

Now with respect to FIG. 2 through 6, internal components of the feed dispensing system 1 will be discussed. FIG. 2 shows major internal components of the feed dispensing system 1 according to the invention, including a storage container 20, a first conveyor system 30, a surge container 40, a second conveyor system 50, a weighing mechanism 60, and the supply duct 14. The storage container 20 is a storage bin capable of holding and storing a large capacity of bulk material 2. For instance, the storage container 20 may be capable of holding tonnage of bulk material 2. The first conveyor system 30 runs from the storage container 20 to the surge container 40, transporting bulk material 2 from the storage container 20 to the surge container 40. The surge container 40 is a smaller storage container than storage container 20, and includes several level sensors 70a, 70b, 70c (shown in FIGS. 5 and 6). The level sensors 70a, 70b, 70c determine current capacity of bulk material 2 within the surge container 40. The second conveyor system 50 transports bulk material 2 from surge container 40 to the weighing mechanism 60. The level sensors 70a, 70b, 70c can control this movement of bulk material 2 from the surge container 30, as well as transportation of bulk material 2 into surge container 40 by means of the first conveyor system 30. Additionally, the level sensors 70a, 70b, 70c provide information on the amount of bulk material 2 left within the feed dispensing system 1, including the storage container 20. The supply duct 14 connects to an end of the weighing mechanism 60 and runs out to the exterior of the housing 10.

The user interface 12, the level sensors 70a, 70b, 70c, the first conveyor system 30, the second conveyor system 50, and weighing mechanism 60 connect to the controller 100, which is used to command functions that control movement of bulk material through the feed dispensing system 1. In the embodiment shown, the controller 100 is integrated with the user interface 12, into a microprocessor of the feed dispensing system 1. However, it is possible that the controller 100 is a standalone component of the feed dispensing system 1, and functions separately from the user interface 12, but performs commands when signals are received from the user interface 12. Fundamentally, the controller 100 controls the working components, by starting and stopping operations, controlling transportation of bulk material, and discharge of bulk material 2 to the customer.

The storage container 20, as shown in FIGS. 2-5, includes a framed hopper 22 and transport mechanism 28, such as an auger. The transport mechanism 28 mounts to a bottom of the framed hopper 22, and in the embodiment shown, functions within the interior of the framed hopper 22. However, it is possible that the transport mechanism 28 is not integrated into the design of the storage container 20, but rather is a separate component that transports bulk material 2 from the storage container 20 to the first conveyor system 30.

In the embodiment shown, the framed hopper 22 includes upper and lower walls 24, 26. The upper walls 24 connect to the lower walls 26, which narrow toward a bottom surface of the framed hopper 22. However, it is possible that framed hopper 22 only include a set of upper walls 24, where one or more upper walls 24 is angled and/or narrowing toward the bottom surface of the framed hopper 22.

Along the bottom surface of the framed hopper 22 is a running passageway 27 which encloses the transport mechanism 28. In the embodiment shown, the bottom surface opens into an interior of the framed hopper 22. The transport mechanism 28 (i.e. auger, conveyor belt) extends from opposite lower ends of the storage container 20 and across the interior of the running passageway 27. The transport mechanism 28 runs to the first conveyor system 30, and is controlled by the controller 100. When activated, the transport mechanism 28 moves bulk material 2, stored in the storage container 20, to the first conveyor system 30. It is also possible, that the transport mechanism 28 is a grain blower that blows bulk material 2 to the first conveyor system 30. Other suitable conveyor systems known to the art may be used.

In other embodiments, it is possible that the transport mechanism 28 is removed and replaced with a angled running passageway 27, which is angled in such a way that bulk material 2 moves into the first conveyor system 30 by gravity or without assistance of a transport mechanism 28.

The storage container 20 stores a large quantity of bulk material 2 (i.e. tonnage of bulk material). In the embodiment shown, the storage container 20 does not include a lid. However, it is possible to provide a lid to seal bulk material 2 in storage container 20, in order to preserve and/or bulk material 2 for sale. The storage container 20 is accessible in several ways. As discussed, a door 4 in the housing 10 provides access for a vendor to supply or re-supply bulk material 2 into the storage container 20, as well as a maintenance worker to perform maintenance. Additionally, a number of inlets 6 are positioned along a roof of the housing 10. These inlets 6 open into the interior of the housing 10. In the embodiment shown, at least one inlet 6 is positioned above the storage container 20. The vendor can access the storage container 20 through the inlets 6, and supply or re-supply bulk material 2 accordingly.

The first conveyor system 30 is shown in FIGS. 2 through 5, and includes a shaft 32 and a transport mechanism 34 in the embodiment shown. The first conveyor system 30 extends from the floor 8 and bottom of the storage container 20 toward the surge container 40. The first conveyor system 30 either connects through an opening in the surge container 40, or extends above the above the surge container 40 in order to deliver bulk material 2 into the surge container 40. The first conveyor system 30 delivers bulk material 2 rather quickly. Using the transport mechanism 34, the first conveyor system 30 transports bulk material 2 through the shaft 32 and into the surge container 40. The transport mechanism 34 is a bulk material handling system, such as an auger (as shown in the embodiments), a belt conveyor, or a bucket elevator, and is activated and controlled by the controller 100.

The first conveyor system 30, in the embodiment shown, has an upright design, where the shaft 32 and transport mechanism 34 extend from the floor 8 vertically. However, it is also possible that the first conveyor system 30 is angled.

The shaft 32 covers the transport mechanism 34, both holding and protecting the bulk material 2, as the bulk material 2 travels up the shaft 32. In addition, the shaft 32 includes channel portions 32a, which precisely direct flow of bulk material 2 from the storage container 20 to the surge container 40. Accordingly, the bulk material 2 is deposited into the surge container at a high rate and without loss of bulk material 2 outside the first conveyor system 30.

The surge container 40 is shown in FIGS. 5 and 6. Unlike the large capacity storage container 20, the surge container 40 is an intermediate storage that includes three level sensors 70a, 70b, 70c, which identify the amount of bulk material in the surge container 40. Since the surge container 40 includes at least one narrowing sidewall 42a in the embodiment shown, wherein a width between opposing sidewalls is greater along a top surface than a bottom surface, the bulk material 2 moves to and through an opening in the bottom of the surge container 40.

In the embodiments show, three level sensors 70a, 70b, 70 are positioned along inner surfaces of surge container 40 in order to detect capacity of bulk material in the surge container. While the embodiment shows three level sensors 70a, 70b, 70c, the surge container 40 could include more or less sensors.

As shown in FIGS. 5 and 6, the surge container 40 includes at least three sensors 70a, 70b, 70c, a full level sensor 70a, a low level sensor 70b, and an empty level sensor 70c. The placement of each level sensor 70a, 70b, 70c depends on the function of the individual sensor 70a, 70b, 70c.

The full level sensor 70a is positioned at an approximate upper most region of the surge container 30, while the empty level sensor 70c would be positioned at a lower most region of the surge container 40. In the embodiment shown, the low level sensor 70b is positioned in an approximate middle of surge container 40. Accordingly, the low level sensor 70b is positioned where bulk material 2 would be at approximately half capacity within the surge container 40. However, the placement and positions of these level sensors 70a, 70b, 70c could vary, as a matter of function for detecting levels of capacity within the surge container 40.

The low level sensor 70b detects when the bulk material 2 is running low in the surge container 40. As bulk material 2 is feed into the surge container 40, the bulk material 2 will maintain a level approximately above the level sensor 70b. When the low level sensor 70b detects that the level of bulk material 2 is below the low level sensor 70b, then a signal is sent to the controller 100 to start flow of bulk material from the first conveyor system 30 and storage container 20. The full level sensor 70a detects when bulk material reaches a substantial maximum in the surge container 40. Therefore, the full level sensor 70a sends a signal to the controller 100 to stop flow of bulk material from the first conveyor system 30 and storage container 20. On the other hand, the empty level sensor 70c detects when bulk material 2 is empty in the surge container 40, or below a satisfactory level determined by the vendor. If the empty level sensor 70c detects that the level of bulk material 2 is below a satisfactory level, then the empty level sensor 70c will send a signal to the controller 100 that prepares a signal displayed on the user interface 12, identifying that the feed dispensing system 1 is empty. The controller 100 shut downs the internal components within the feed dispensing system 1.

Additionally, in the embodiment shown, a transceiver is connected to the controller 100 within the user interface 12. The transceiver sends signals to the vendor that the bulk material 2 is at low capacity or that the feed dispensing system 1 requires maintenance.

As shown in FIG. 5, the surge container 40 includes an opening along a bottom surface of the surge container 40, which allows bulk material 2 to move into the second conveyor system 50. The second conveyor system 50 includes a shaft 52, which runs under the surge container 40, and a transport mechanism 54. The second conveyor system 50 extends from the opening in the surge container 40 toward the weighing mechanism 60. The second conveyor system 50 either connects through an opening in the weighing mechanism 60, or extends above the above the weighing mechanism 60 in order to deliver bulk material 2 into the weighing mechanism 60.

The second conveyor system 50 delivers bulk material 2 more slowly than the first conveyor system 30. The second conveyor system 50 delivers feed from the surge container 40 up the shaft 32 by the transport mechanism 54. The transport mechanism 54 is another bulk material handling system, such as an auger, as shown. However, the transport mechanism 54 could also be a belt conveyor or bucket elevator, or another type of bulk material handling system, capable of transporting bulk material to the weighing mechanism 60 without a pulsing effect on the weighing mechanism, where the weighing mechanism can efficiently and effectively measure out bulk material for customer orders.

The second conveyor system 50 is angled in the embodiment shown. Additionally, the second conveyor system 50 is connected to the controller 100, which not only activates the second conveyor system 50, but further controls the speed of the second conveyor system 50 in order to control the amount of bulk material 2. More specifically, the controller 100 can control the speed at which the second conveyor system 50 operates.

The second conveyor system 50, in the embodiment shown, includes the shaft 52 that covers the transport mechanism 54. In addition, the shaft 52 includes channel portions 52a to precisely direct flow of bulk material 2 from the surge container 40 to the weighing mechanism 60.

The weighing mechanism 60, according to the invention, and shown in FIGS. 5-7, includes a frame 62, a scale 64 and a control mechanism 66 fixedly attached thereto. The frame 62 is a hopper for receiving bulk material, which is then measured by the scale 64. The frame 62 narrows from its upper ends to its lower ends, right above the scale 64. The control mechanism 66 is in communication with the controller 100 of the feed dispensing system 1, and continuously determines the amount of bulk material 2 transported onto the scale 64. The scale 64 of the feed dispensing system 1 is a weighing scale or measuring instrument for determining the weight or mass of bulk material 2. Accordingly, the scale 64 and attached control mechanism 66 calculate orders of bulk material 2, approximately measuring out a predetermined amount of bulk material 2. Once the cycle completes, and the control mechanism 66 determines when the amount of bulk material 2 measures that which is ordered, the control mechanism 66 activates discharge of the bulk material 2 from the frame 62 and into the supply duct 14. Hence, an order is completed.

As discussed, the second conveyor system 50 is capable of transporting bulk material 2 at various speeds, including a crawling speed where the feed dispensing system 1 can measure out a predetermined amount of bulk material efficiently and approximately. In the embodiment shown, the control mechanism 66 is part of the controller 100 housed in the user interface 12. However, the control mechanism 66 could be a separate control unit, which communicates with the controller 100.

In order to operate the feed dispensing system 1, a user selects a quantity of bulk material using a user interface 12. The user interface 12 and controller 100 send signals to the second conveyor system 50 to transport bulk material 2 from a surge container 30 to the weighing mechanism 60. The bulk material 2 is uniformly dispersed into or onto the weighing mechanism 60, which measures the quantity of the bulk material on the weighing mechanism 60. The second conveyor system 50 slows as the weighing mechanism 60 measures an approaching predetermined amount of ordered bulk material 2. Once bulk material 2 reaches the predetermined amount of ordered bulk material 2, the weighing mechanism 60 discharges bulk material through the supply duct 14.

Additionally, level sensors 70a, 70b, 70c monitor the capacity of bulk material 2 in the surge container 40. If the level sensors 70a, 70b, 70c determine that the capacity of bulk material 2 is low, as discussed above, the level sensors 70a, 70b, 70c send signals to the controller 100, which activates the transportation of bulk material 2 from the storage container 20 to the surge container 40. If the level sensors 70a, 70b, 70c determine that the amount of bulk material 2 is low within the feed dispensing system 1, a signal is sent from the transceiver to the vendor of the feed dispensing system 1.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed:

1. A feed dispensing machine, comprising:
a controller;
a storage container;
a surge container;
a first conveyor system connecting the storage container to the surge container;
a level sensor positioned within the surge container and signaling capacity of a bulk material within the surge container;
a weighing mechanism having a scale and connecting to the controller; and
a second conveyor system connecting the surge container and the weighing mechanism, the second conveyor system positioned above the scale.

2. The feed dispensing machine according to claim 1, further comprising a user interface having a display unit and money acceptor.

3. The feed dispensing machine according to claim 2, further comprising a supply duct positioned adjacent to the display unit.

4. The feed dispensing machine according to claim 3, further comprising a housing enclosing the storage container, surge container and weighing mechanism.

5. The feed dispensing machine according to claim 4, wherein the display unit is positioned on a surface of the housing.

6. The feed dispensing machine according to claim 1, wherein the controller is a microprocessor in a user interface.

7. The feed dispensing machine according to claim 1, wherein the first conveyor system is a vertical auger extending from a bottom of the storage container to a top of the surge container.

8. The feed dispensing machine according to claim 1, wherein the surge container has a narrowing sidewall, wherein a width between opposing sidewalls is greater along a top surface than a bottom surface.

9. The feed dispensing machine according to claim 1, wherein the level sensor is positioned along an inner surface of the surge container.

10. The feed dispensing machine according to claim 9, wherein the surge container has at least two level sensors including a low level sensor and an empty level sensor.

11. The feed dispensing machine according to claim 10, wherein the low level sensor connects to the controller for controlling the first conveyor system.

12. The feed dispensing machine according to claim 11, wherein the low level sensor is positioned to determine approximate half capacity of the bulk material within the surge container.

13. The feed dispensing machine according to claim 12, wherein the low level sensor activates the first conveyor system when the bulk material is below the position of the low level sensor.

14. The feed dispensing machine according to claim 10, wherein the empty level sensor connects to a user interface.

15. The feed dispensing machine according to claim 14, wherein the empty level sensor is positioned to sense an unsatisfactory low level of bulk material in the surge container.

16. The feed dispensing machine according to claim 15, wherein the empty level sensor sends a signal to the user interface displaying a notification of the unsatisfactory low level of bulk material.

17. The feed dispensing machine according to claim 1, further comprising a transceiver that sends a signal to a vendor in response to a level sensor signal.

18. The feed dispensing machine according to claim 1, wherein the second conveyor system is an angled auger.

19. The feed dispensing machine according to claim 1, wherein the scale is connected to a controller.

20. The feed dispensing machine according to claim 19, wherein the second conveyer system is connected to the controller, the controller controlling a speed of the second conveyer system.

21. The feed dispensing machine according to claim 20, wherein the controller is a computer.

22. The feed dispensing machine according to claim 1, further comprising a supply duct connecting to the weighing mechanism.

23. The feed dispensing machine according to claim 1, wherein the supply duct extends from inside and through the housing.

24. The feed dispensing machine according to claim 1, further comprising a transport mechanism along an underside of the storage container, the transport mechanism connecting to the first conveyor system.

25. A method of distributing bulk material, comprising the steps of:
selecting a weight of bulk material using a user interface;
transporting bulk material from a surge container to a weighing mechanism using a conveyer system;
distributing bulk material uniformly onto a weighing mechanism using the conveyer system;
measuring bulk material of feed on the weighing mechanism;
stopping the conveyer system once the quantity of bulk material is measured on the weighing mechanism;
monitoring a capacity of bulk material in the surge container through a level sensor; and
transferring measured bulk material from weighing mechanism through a supply duct.

26. The method of distributing bulk material according to claim 25, further comprising the steps of:
storing feed in a storage container; and
transporting feed from the storage container to the surge container.

27. The method of distributing bulk material according to claim 26, further comprising the steps of:
determining the capacity of bulk material in the surge container by at least two level sensors.

28. The method of distributing bulk material according to claim 27, wherein the at least two level sensors are positioned along inner surfaces of surge container.

29. The method of distributing bulk material according to claim 28, wherein the at least two level sensors are a low level sensor and an empty level sensor.

30. The method of distributing bulk material according to claim 29, further comprising the steps of:
determining an approximate half capacity of the bulk material in the surge container by the low level sensor; and
ceasing the transportation of feed from the storage container to the surge container.

31. The method of distributing bulk material according to claim 30, further comprising the steps of:
determining an unsatisfactory low level of bulk material in the surge container by the empty level sensor; and
signaling empty by the user interface.

32. The method of distributing bulk material according to claim 31, further comprising the step of:
signaling a vendor of the unsatisfactory low level of bulk material.

34. A system for distributing feed, comprising:
an interface module;
a supply duct module; and
a housing enclosing:
a surge container module connected to the interface module;
a sensor module positioned within the surge container module;
a weighing module positioned adjacent to the surge container module; and
a conveyor module connected to the surge container module and transporting feed to the weighing module, the conveyor module running from a bottom of the storage module to above the weighing module;
wherein the supply duct module connects to the weighing module and extends outside the housing.
